(19) United States
(12) Patent Application Publication
(10) Pub. No.: US 2023/0271149 A1
(43) Pub. Date: Aug. 31, 2023

(54) SYSTEM AND METHOD FOR COLORING STAIN

(71) Applicant: Sashco, Inc., Brighton, CO (US)

(72) Inventors: James Barnes, Brighton, CO (US); Paul Peebles, Brighton, CO (US)

(21) Appl. No.: 18/113,759

(22) Filed: Feb. 24, 2023

Related U.S. Application Data
(60) Provisional application No. 63/313,804, filed on Feb. 25, 2022.

(51) Int. Cl. B01F 35/71; B01F 23/40

(52) U.S. Cl. CPC B01F 35/71791; B01F 23/405; B01F 35/71715; B01F 2101/30

(57) ABSTRACT

The technology of the present application provides a flex or flexible tint system for stains. In certain aspects, the system comprises a known volume of an unpigmented stain and a colorant cartridge of containing a known volume of colorant. The colorant cartridge has a movable bottom and a discharge nozzle at the top. The movable bottom is movable along the colorant cartridge to consistently deliver a known discharge volume of colorant to the known volume of unpigmented stain. The colorant and unpigmented stain are mixed to achieve a stain of the desired color consistently.

### CROSS-REFERENCE TO RELATED APPLICATIONS

The present application is a non-provisional of U.S. Provisional Patent Application Ser. No. 63/313,804, titled “Flex Tint”, filed Feb. 25, 2022, which is incorporated herein as if set out in full.

### BACKGROUND

The technology of the present application relates to wood finishes, coatings, paints, and stains and, more particularly, to a flex tint method, apparatus, and/or system to color finishes, coatings, paints, and stains.

Wood working often involves stains, finishes, paints and coatings (hereinafter generically “stains”) for the wood product, be it a desk, cabinet, floor, or building siding (hereinafter generically “wood product” or “wood products”). The stains for the wood products are typically formed by adding a colorant to an unpigmented liquid base to form a color stain.

Conventionally, obtaining a color stain for a job site can be accomplished in multiple ways. One way is simply ordering the color stain in advance of the project. Ordering the color stain in advance can be less than desirable for multiple reasons including, for example, ordering too much stain, which is wasteful and increases cost, or ordering too little stain, which causes delay as additional stain is ordered or bought. Another way of obtaining the color stain at the job site is accomplished by mixing the color stain directly at the job site. Conventionally, mixing the stain at the job site involves adding a colorant or colorant mixture to unpigmented liquid base and stirring the mixture. Mixing the colorant with the unpigmented liquid base is problematic for a number of reasons. In particular, the delivery container for the colorant is less than desirable.

Colorant presently is delivered using cans, bottles, and/or bags (hereinafter “container”), all of which have at least two common difficulties. One common difficulty includes getting the colorant out of the container. Cans typically need to be scraped, which leaves a portion of the colorant in the can or at least an undeterminable residue. Bottles need to be squeezed and specially hung over a bucket, or the like, for an extended period of time to facilitate drainage, which typically leaves an undeterminable amount or residual in the bottle, depending on the angle at which the bottle is hung and the length of time. Bags need to be massaged, squeezed, and otherwise manipulated to get the colorant out, which also typically leaves an undeterminable amount of residue behind. Other common difficulty is the variability of the person getting the colorant out of the container, (e.g., how diligently does a person scrape the can, hang the bottle, or manipulate the bag), all of which makes matching colors between batches of stains difficult and sometimes impossible. Additionally, each of the common ways of moving the colorant from the container to the stain to which the colorant is to be added is messy.

Thus, against this background, it would be desirable to provide an improved apparatus for storing and delivering colorant such that it can be mixed with a stain to be colored.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In some aspects of the technology, a stain container and a colorant cartridge are provided. The stain container contains, in certain embodiments, a known volume of unpigmented stain. The colorant cartridge comprises a cylindrical body having a known volume of colorant. The colorant cartridge has a top and a bottom. The top of the colorant cartridge has a sealable nozzle, which may be sealed by a cap and/or a foil. The bottom of the colorant cartridge is movable within the cartridge. The colorant cartridge is configured to fit in a caulking gun. The technology may include actuating the caulking gun such that the movable bottom moves from a distal end of the colorant cartridge to a proximal end of the colorant cartridge to discharge a known volume of colorant. A mixer mixes the unpigmented stain and the colorant discharged from the colorant cartridge.

In some embodiments, the technology of the present application provides a method for mixing a color stain. The method comprises providing a known volume of an unpigmented stain in a stain container. A known volume of a colorant is provided in a colorant cartridge. The colorant cartridge is aligned over an opening in the stain container and the colorant is discharged into the unpigmented stain. The colorant and unpigmented stain are mixed until the colored stain is achieved.

These and other aspects of the present system and method will be apparent after consideration of the Detailed Description and Figures herein. It is to be understood, however, that the scope of the invention shall be determined by the claims as issued and not by whether given subject matter addresses any or all issues noted in the Background or includes any features or aspects recited in this Summary.

### DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 shows a system for storing colorant and delivering colorant from a cartridge consistent with the technology of the present application.

FIG. 2 shows a cartridge from FIG. 1 in more detail consistent with the technology of the present application.

FIG. 3 shows a perspective view of two exemplary colorant cartridges consistent with the technology of the present application.

FIG. 4 shows a view of a caulking gun used with the colorant cartridges of FIG. 3 consistent with the technology of the present application.

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

The technology of the present application is described with specific reference to storing colorant and adding the colorant to an unpigmented liquid base stain for wood stains. For simplicity, colorant in this application generally includes a fluid that suspends particles that provide a tint. However, the technology described herein may be used with applications other than those specifically described herein. For example, the technology of the present application may be applicable to paints, inks, or the like. Moreover, the technology of the present application will be described with relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

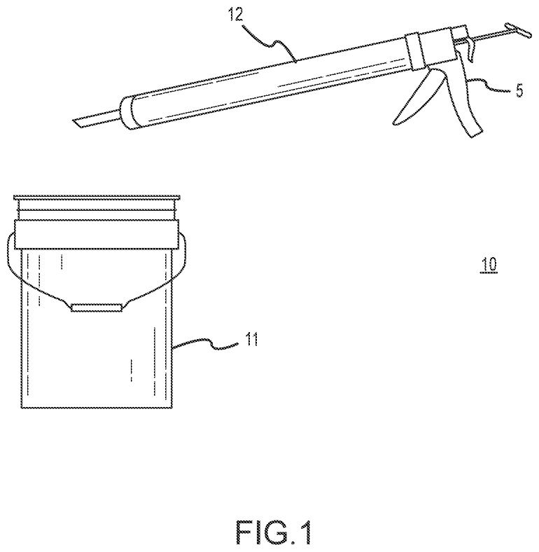

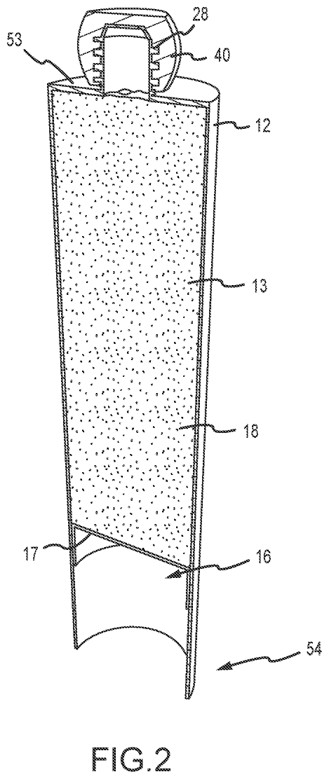

With reference now to FIGS. 1 and 2, a system 10 for storing and delivering a colorant is provided. The system 10 may be considered a flex or flexible tint system as unpigmented stain can consistently be colored to a desired color as the stored colorant is capable of being consistently delivered to the unpigmented stain as will be explained.

With reference to FIG. 1, the system 10 includes a stain container 11 and colorant cartridge 12 for holding a colorant 18 (FIG. 2). Stain container 11 generally contains an unpigmented liquid stain in a predefined volume, such as a five-gallon drum, but typically range from as small as about a quart to as large as a fifty-five gallon drum or larger, although the present technology will work with larger or smaller volumes. The colorant cartridge 12, explained further below, may be held in a caulking gun 5 (another example of which is shown in FIG. 4) that discharges the contents of the colorant cartridge 12. Once the colorant is discharged into the stain container 11, a mixer (not specifically shown) is used to mix the stain and colorant until the colorant is mixed into the stain. The mixer may be a manual or automatic mixer.

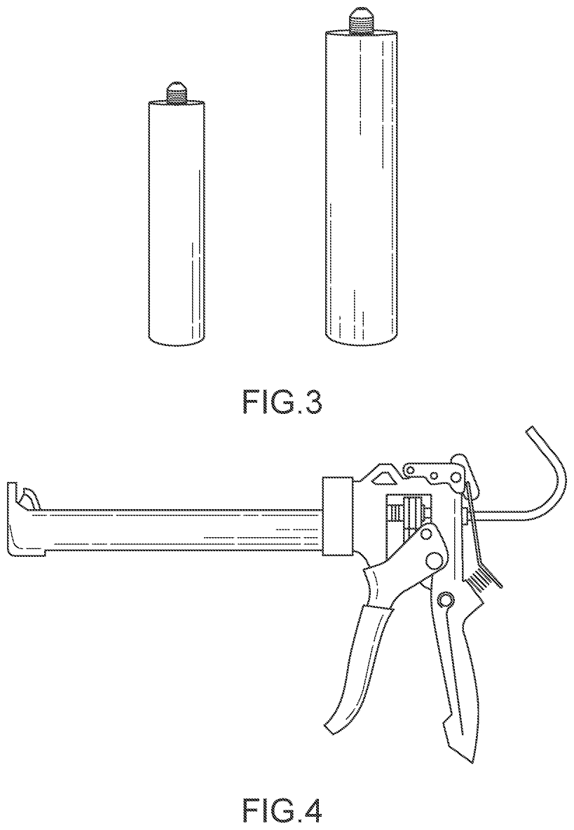

With reference to FIG. 2, the colorant cartridge 12 is shown in additional detail in a cross-sectional view. FIG. 3 shows exemplary colorant cartridges 12 also. The colorant cartridge 12, as shown, has a rigid cylindrical wall 54, or similar, forming the body of the colorant cartridge 12. The colorant cartridge 12 has an interior space 16, formed by the rigid cylindrical wall, comprising a predetermined volume 13. The colorant cartridge 12 contains the colorant 18 in the volume 13 of the space 16. The colorant 18 is generally a fluid, typically a liquid but depending on the viscosity, may be a gel. The colorant 18 may fill the entire space 16 and volume 13 or, there may be a head space (not shown) in the space 16. It is envisioned the colorant 18 will fill the entire space 16 of the colorant cartridge 12 in the normal course, but the colorant cartridge 12 dispenses a known volume of a known concentration of a colorant 18, unlike conventional colorant containers described above. The known or predetermined volume 13 of colorant includes a discharge volume and a residual volume. The residual volume is the amount retained in the nozzle and colorant cartridge subsequent to discharging the colorant.

The colorant cartridge 12 has a top 53 (sometimes referred to as top end or proximal end) with a nozzle 28. The nozzle 28 has a discharge opening that is sealed with a foil seal, a cap 40 as shown, both, or the like, until the colorant is to be discharged. The nozzle 28 has an opening opposite the discharge opening that is in fluid communication with the space 16 such that the colorant 18 can be pushed from the colorant cartridge 12 through the nozzle 28 into a stain container (FIG. 1), which will typically have an unpigmented liquid stain that is to be mixed with the colorant 18. As was explained above and will be explained further below, the stain container will have a predetermined volume, such as the aforementioned five gallons of unpigmented liquid stain.

The colorant cartridge 12 has a bottom wall 17. The bottom wall 17 (or plunger 17) is movable along a long axis of the colorant cartridge 12. The bottom wall 17 has a circular shape to operatively engage and move along the sidewalls of the colorant cartridge 12. As the bottom wall 17 moves from a distal end of the colorant cartridge 12 (or bottom) to the proximal end of the colorant cartridge 12 (or top), the colorant 18 is pushed through the nozzle 14 into the stain container 11.

As explained above, the colorant container 12 has a predetermined volume 13. The predetermined volume 13 depends, in part, on the volume of the stain container. Typically, for a five-gallon stain container of unpigmented base liquid stain, the colorant container 12 will have a volume of 10.5 ounces or 28 ounces, to name but two exemplary sizes, although the actual amount of colorant in the colorant cartridge will depend on the product and the amount of colorant needed to obtain the proper tinting. The exact ratio for the volume of the stain container and the volume of the colorant cartridge 12 depends in part on the concentration of the colorant 18 in the colorant container 12. The colorant 18 will generally be a fluid, such as a liquid or a gel. In some instances, the colorant 18 has a relatively high viscosity as compared to conventional colorant. Having a relatively high viscosity helps the suspended colorants to remain suspended. Also, if the nozzle is cut or the foil seal on the nozzle is removed, and the colorant cartridge nozzle is allowed to dip down, the high viscosity inhibits the colorant 18 from leaking out of the nozzle.

During use, the stain container 11 containing an unpigmented liquid stain is provided. The stain container 11 is opened. The colorant container 12 containing the colorant 18 is provided. The colorant container 12 is opened by, for example, cutting the nozzle or removing the foil seal from the discharge opening of the nozzle 28. The nozzle 28 is placed in or over the opening of the stain container 11. The bottom wall 17 of the colorant container 12 is moved from the bottom 54 (sometimes referred to as the bottom end or distal end) of the colorant container 12 to the proximal end of the colorant container 12 until the bottom wall 17 stops, discharging a known volume of colorant 18 into the stain container 11. The bottom wall 17 typically stops when it reaches the top wall, but the interior of the colorant container 12 may have a stop (not shown) to stop the movement of the bottom wall 17 in certain embodiments.

Because the colorant container 12 and the movement of the bottom wall 17 are known, the total volume of colorant 18 to be added to the unpigmented liquid stain is known. Generally, the total volume of the colorant 13 may be considered in two portions: a discharge volume and a residual volume. Because all the dimensions are known, the discharge volume and the residual volume are known. It is envisioned that the colorant cartridge will have minimal residual volume after discharge. Finally, the mixture of the unpigmented liquid stain and colorant is mixed to form a colored stain, which is contained in the stain container 11. The colored stain is consistent for each colorant container 12 and stain container 11 used as the volumes and concentrations are known in advance. The colorant cartridge 12 is specifically sized to the stain container 11 to ensure the same volume of colorant 18 is discharged into the satin container, no matter the user discharging the colorant 18 from the colorant cartridge 12. This ensures a constant stain color no matter the care of the user. The colorant cartridge 12 also minimizes waste as the colorant cartridge 12 is designed to minimize unused colorant 18 (e.g., minimize the residual volume). Generally, the only unused colorant 18 will be the residual contained in the nozzle 14 once the bottom wall stops. Finally, because the colorant cartridge 12 is sealed and the nozzle 14 can be placed in or proximal to the stain container 11, the transfer of the colorant 18 from the colorant cartridge 12 is much less messy than the transfer of colorant from conventional containers.

Mixing the colorant 18 can be manual. Manual mixing may be, for example, using a drill with a mixing attachment at a speed that thoroughly mixes the colorant in the stain container without causing splashing. Automatic mixing may be, for example, using an agitator or the like by resealing the stain container 11 after the colorant 18 is discharged into the stain container.

Although the technology has been described in language that is specific to certain structures, materials, and methodological steps, it is to be understood that the invention defined in the appended claims is not necessarily limited to the specific structures, materials, and/or steps described. Rather, the specific aspects and steps are described as forms of implementing the claimed invention. Since many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. A system for coloring a stain comprising,
a stain container having a known volume of stain;
a colorant cartridge having a known volume of a colorant, the colorant cartridge having a nozzle, the known volume including a discharge volume and a residual volume; and
a mixer, wherein
the nozzle of the colorant is aligned over an opening of the stain container and the discharge volume of the colorant is discharged into the stain container, wherein
the mixer mixes the known volume of stain and the discharge volume of the colorant.

2. The system of claim 1 wherein the stain is unpigmented.

3. The system of claim 1 wherein the colorant has a viscosity sufficient to maintain the particles suspended in the colorant cartridge.

4. The system of claim 1 wherein the colorant has a viscosity sufficient such that the colorant does not leak from an open nozzle.

5. The system of claim 1 wherein the colorant cartridge nozzle is sealed.

6. The system of claim 5 wherein the colorant cartridge nozzle is sealed by a seal selected from the group of seals consisting of a cap or a foil.

7. The system of claim 1 wherein the colorant cartridge comprises a cylindrical wall and a movable bottom wherein moving the movable bottom from a distal end to a proximal end causes the colorant to discharge from the nozzle.

8. The system of claim 7 comprising a caulking gun configured to hold the colorant cartridge and engage the movable bottom and to move the movable bottom from the distal end to the proximal end.

9. The system of claim 1 wherein the stain container contains five gallons of unpigmented stain.

10. The system of claim 9 wherein the colorant cartridge contains a sufficient amount of colorant to cause the five gallons of unpigmented stain to achieve a tint.

11. A method of mixing a colored stain comprising:
providing a stain container comprising a known volume of stain;
aligning a colorant cartridge having a movable bottom and a top with a nozzle over an opening of the stain container;
causing the movable bottom of the colorant cartridge to move from a distal end of the colorant cartridge towards the proximal end of the colorant cartridge;
discharging, substantially simultaneously as causing the movable bottom to move, the colorant into the stain container until a discharge volume of colorant has been discharged; and
mixing the stain and the colorant in the stain container.

12. The method of claim 11 comprising removing a seal from the nozzle prior to aligning the colorant cartridge over the stain container.

13. The method of claim 11 wherein the stain is unpigmented.

14. The method of claim 11 wherein aligning the colorant cartridge comprises placing the colorant cartridge in a caulking gun.

15. The method of claim 14 wherein causing the movable bottom of the colorant cartridge to move comprises actuating the caulking gun.

16. A system for coloring a stain comprising,
a stain container having a known volume of stain; and
a colorant cartridge having a known volume of a colorant, the colorant cartridge having a nozzle, a cylindrical wall, and a movable bottom wherein moving the movable bottom from a distal end to a proximal end causes the colorant to discharge from the nozzle, the known volume including a discharge volume and a residual volume.

17. The system of claim 16 wherein the stain is unpigmented.

18. The system of claim 16 wherein the colorant has a viscosity sufficient to maintain the particles suspended in the colorant cartridge.

19. The system of claim 16 wherein the colorant has a viscosity sufficient such that the colorant does not leak from an open nozzle.

20. The system of claim 16 comprising a caulking gun configured to hold the colorant cartridge and engage the movable bottom and to move the movable bottom from the distal end to the proximal end.
